(19) United States
(12) Patent Application Publication
(10) Pub. No.: US 2015/0148003 A1
(43) Pub. Date: May 28, 2015

(54) Adaptive Request Processing Service For Charging Requests

(71) Applicant: Oracle International Corporaton, Redwood Shores, CA (US)

(72) Inventors: Louis Thomas Piro, JR., San Jose, CA (US); Jens Kaemmerer, Pacific Grove, CA (US)

(73) Assignee: Oracle International Corporaton, Redwood Shores, CA (US)

(21) Appl. No.: 14/199,457

(22) Filed: Mar. 6, 2014

Related U.S. Application Data
(60) Provisional application No. 61/908,588, filed on Nov. 25, 2013.

(51) Int. Cl. H04M 15/00

(52) U.S. Cl. CPC H04M 15/31
USPC 455/406

(57) ABSTRACT

The present disclosure provides a method, non-transitory computer readable storage medium, and apparatus that implement an adaptable payload object model. In one embodiment, a payload object is generated using a payload specification that defines a plurality of payload attributes, where the payload object includes the plurality of payload attributes. The plurality of payload attributes of the payload object are populated with message attribute values that are extracted from an incoming message. The plurality of payload attributes of the payload object is validated. In one embodiment, an outgoing message is built that includes the payload object and is forwarded to a destination, such as a subscriber or a charging engine.

### CROSS-REFERENCE TO RELATED APPLICATIONS

The present patent application claims priority to Provisional Patent Application Ser. No. 61/908,588, filed Nov. 25, 2013, and entitled “Adaptive Data Model for Charging Requests,” which is hereby incorporated by reference herein, in its entirety and for all purposes.

### FIELD OF THE INVENTION

The present disclosure relates to charging domains, and more particularly, to messages exchanged in a charging domain.

### BACKGROUND OF THE INVENTION

Service providers are experiencing ever-growing service usage by subscribers. A service provider implements a charging system in which subscribers are charged for their service usage. An example charging system may implement a policy and charging control solution, such as that developed under 3GPP™ (3rd Generation Partnership Project) IMS (Internet Protocol Multimedia Subsystems) and provides a new standard for charging system business models.

### BRIEF DESCRIPTION OF THE DRAWINGS

The present invention may be better understood, and its numerous objects, features and advantages made apparent to those skilled in the art by referencing the accompanying drawings.

FIG. 1 is a simplified block diagram illustrating components of an example charging system in which the present disclosure can be implemented, according to one embodiment.

FIG. 2 is a simplified block diagram illustrating components of an example adaptive request processing service module in which the present disclosure can be implemented, according to one embodiment.

FIGS. 3A and 3B are simplified block diagrams illustrating components of example payload definition text files, according to one embodiment.

FIGS. 4A and 4B are simplified block diagrams illustrating components of an example object model diagram that illustrates the relationships among various object constructs used to implement payload specifications, according to one embodiment.

FIG. 5A is a simplified block diagram illustrating an example message builder instantiation process, according to one embodiment.

FIG. 5B is a simplified block diagram illustrating an example payload object generation process for a message destined for a charging engine, according to one embodiment.

FIG. 5C is a simplified block diagram illustrating an example payload object generation process for a message destined for a subscriber, according to one embodiment.

FIG. 6 is a flowchart illustrating an example payload specification generation process, according to one embodiment.

FIG. 7 is a flowchart illustrating an example builder management process, according to one embodiment.

FIG. 8 is a flowchart illustrating an example message generation process, according to one embodiment.

FIG. 9 is a flowchart illustrating an example payload object generation, payload object population, and message build process, according to one embodiment.

FIG. 10 is a simplified block diagram of a computer system suitable for implementing aspects of the present disclosure, according to one embodiment.

FIG. 11 is a simplified block diagram of a network architecture suitable for implementing aspects of the present disclosure, according to one embodiment.

While the present disclosure is susceptible to various modifications and alternative forms, specific embodiments of the present disclosure are provided as examples in the drawings and detailed description. It should be understood that the drawings and detailed description are not intended to limit the present disclosure to the particular form disclosed. Instead, the intention is to cover all modifications, equivalents, and alternatives falling within the spirit and scope of the present disclosure as defined by the appended claims.

### DETAILED DESCRIPTION

### Overview

The present disclosure provides a method, non-transitory computer readable storage medium, and apparatus that implement an adaptable payload object model. In one embodiment, a payload object is generated using a payload specification that defines a plurality of payload attributes, where the payload object includes the plurality of payload attributes. The plurality of payload attributes of the payload object are populated with message attribute values that are extracted from an incoming message. The plurality of payload attributes of the payload object are validated. In one embodiment, the payload object is inserted into an outgoing message and forwarded to a destination, such as a subscriber or a charging engine.

### Example Embodiments

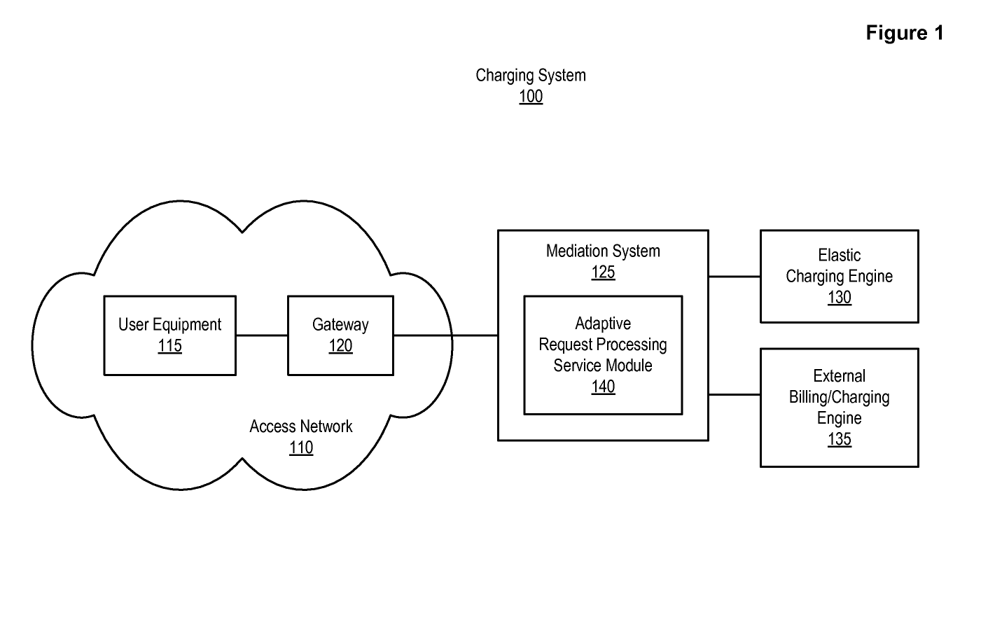

FIG. 1 is a simplified block diagram illustrating components of an example charging system 100 in which the present disclosure can be implemented. A service provider (such as a telecommunication service provider, a shipping service provider, a utility service provider, etc.) provides subscribers with access to one or more service products. A service provider can implement a charging system 100 that is configured to define and enforce conditions that indicate how subscribers should be charged for service usage. As illustrated, charging system 100 includes an access network 110, a mediation system 125, an elastic charging engine 130, and/or an external billing/charging engine 135. Access network 110 includes one or more user equipment 115 and one or more gateways 120. Each component is discussed below.

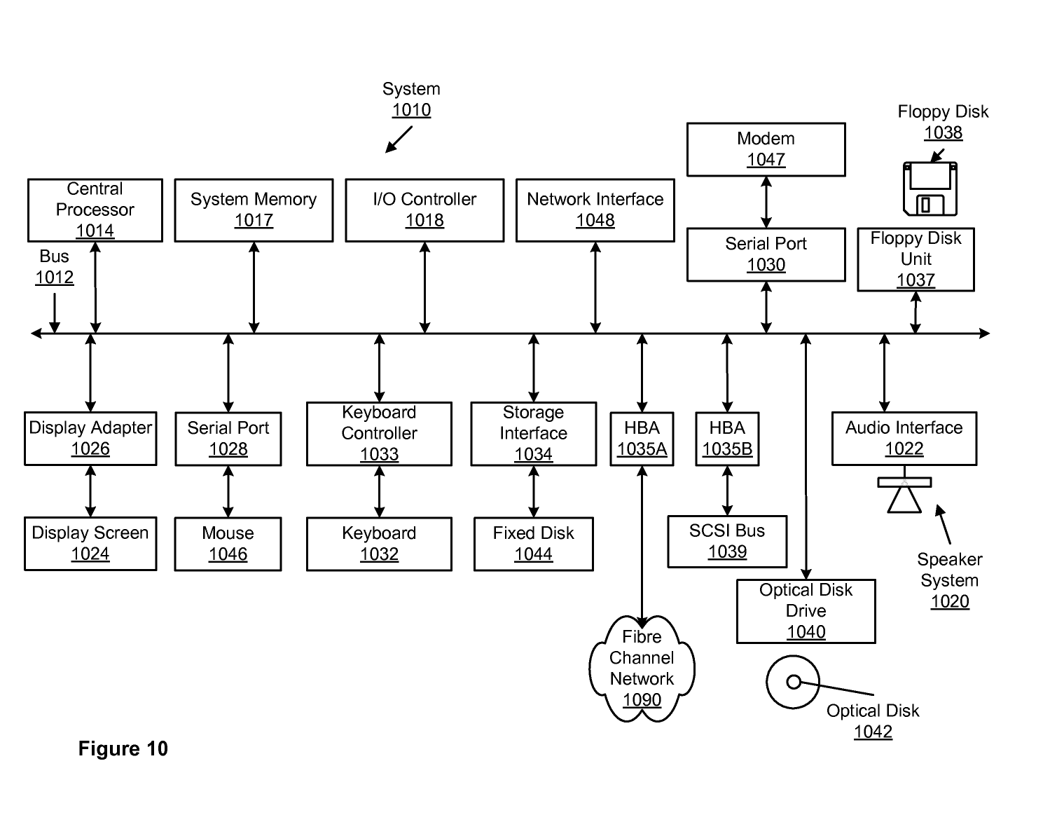

User equipment 115 is a computing device of a subscriber (or a user of a service). Examples of user equipment 115 include a computing device (e.g., a mobile phone, a smartphone, a tablet computer, a laptop computer), a terminal, a kiosk, and like devices that are utilized to access a service. Computing devices are further discussed below in connection with FIG. 10. User equipment 115 is configured to communicate with mediation system 125 via gateway 120 in access network 110. Examples of access network 110 include an IP (Internet Protocol) network, a telecommunications network, or other network that provides a subscriber with connectivity to mediation system 125. Examples of gateway 120 include a computing device, such as a server or switch device that is communicatively coupled to mediation system 125. Although only a single user equipment 115 and gateway 120 are illustrated in FIG. 1, more than one user equipment 115 and gateway 120 can be implemented in access network 110.

Elastic charging engine 130 is configured to perform calculation of charges that arise from a subscriber's service usage. Elastic charging engine 130 can be implemented on one or more processing nodes, where the one or more processing nodes are implemented on one or more servers (such as on a grid-based high availability cluster of servers), where a server can be implemented on one or more computing devices. Elastic charging engine 130 includes one or more charging components, each of which is responsible for performing a portion of the calculations needed to charge the subscriber for service usage. The charging components of elastic charging engine 130 can be implemented on the one or more processing nodes of elastic charging engine 130.

External billing engine and/or charging engine 135 may optionally be implemented in charging system 100. If implemented in charging system 100, external billing/charging engine 135 is distinct from elastic charging engine 130 and is configured to perform billing of charges for subscribers and/or additional calculation of charges that arise from a subscriber's service usage. External billing engine/charging engine 135 can be implemented on one or more processing nodes, where the one or more processing nodes are implemented on one or more servers (such as on a grid-based high availability cluster of servers), where a server can be implemented on one or more computing devices. External billing/charging engine 135 also includes one or more charging components, each of which is responsible for performing a portion of the calculations needed to bill and/or additionally charge the subscriber for service usage. The charging components of external billing/charging engine 135 can be implemented on the one or more processing nodes of external billing/charging engine 135. Usage of “charging engine” herein generally refers to a charging engine implemented in charging system 100, which includes charging engine 130 and external billing/charging engine 135.

Mediation system 125 can be implemented on one or more servers, where a server can be implemented on one or more computing devices. Mediation system 125 is communicatively coupled to both elastic charging engine 130 and external billing/charging engine 135. When a subscriber wishes to utilize a service, user equipment 115 of the subscriber is configured to send a service request to mediation system 125 via gateway 120. Mediation system 125 is configured to generate a corresponding charging request and route the charging request to the appropriate charging component of elastic charging engine 130 or external billing/charging engine 135. Each charging request includes a payload that contains information in the form of attributes about the subscriber's service usage, such as the type of service being utilized and service usage measurements (e.g., volume-, time-, or event-based service usage measurements). Elastic charging engine 130 and external billing/charging engine 135 are configured to utilize the payload to charge the subscriber.

Different service providers charge subscribers differently, where a service provider's charging engine performs charging operations for a subscriber based on payload attributes that are often specific to the service provider's charging domain. For example, a charging engine in a telecommunications charging domain would need to receive attributes related to voice usage or data usage, while a charging engine in a shipping charging domain would need to receive attributes related to package size and weight. Other example charging domains include (but are not limited to) a toll road charging domain (e.g., receives attributes related to distance traveled), a telephone charging domain (e.g., receives attributes related to call duration), and a pay per view video charging domain (e.g., receives attributes related to the requested video). Often, a charging engine is built for a particular charging domain, where the charging engine supports the particular attributes needed to charge a subscriber in the particular charging domain.

Some charging systems today attempt to support multiple charging domains by overloading the payload with different sets of attributes that are related to each of the multiple charging domains, resulting in a “kitchen sink” union of all types of charging request payloads (where only one out of the multiple sets of attributes would actually be used in a given charging domain). This approach produces a payload that is larger in size than necessary (due to the excessive number of attributes included in the payload, many of which are unused), which in turn makes the payload expensive to transport across network devices and to persist in memory. This approach also fails to provide a service provider with guidance as to what attributes are required by a specific charging operation, meaning the payload is complicated to construct and implement.

Other charging systems attempt to support multiple charging domains by expressing the payload in abstract terms (e.g., Field1, Param2, and the like). This approach is difficult to implement due to the non-descriptive nature of the abstract terms and the lack of guidance as to what attributes are required by a specific charging operation, meaning the payload is complicated to construct and implement. Additionally, some charging systems fail to validate the payload prior to submitting the charging request to the charging engine. This failure to validate may result in charging errors that occur during runtime charging due to incomplete payloads (e.g., the charging engine does not receive all the information needed to calculate charges) and/or invalid payloads (e.g., the charging engine receives information that is not compatible with the information the charging engine expected to receive).

The present disclosure provides an adaptable payload object model that is used to model different types of payloads and supports the various attributes specified by any particular service provider. A payload definition is a text file that defines a number of attributes carried by a particular type of payload. Multiple payload definition text files can be created, one for each type of payload used in the charging system. A payload definition text file can be created by an administrator of a service provider using a simple text-based domain specific language (DSL) that is applicable to a payload domain, which is a charging domain that uses payloads to perform charging operations (such as the charging domains mentioned above). The DSL, which has a small vocabulary and is easy to learn, allows an administrator to define payload attributes that are specific to the charging domain, without requiring extensive programming knowledge (as opposed to an XML (extensible markup language) based solution, which would burden the service provider by requiring constructs that are not required for the charging domain). The administrator can use DSL to define descriptive attribute names that accurately describe the attributes being used in the charging system, which provides clearer guidance as to what attributes are required by a particular charging operation and prevents runtime charging errors (e.g., errors due to the charging engine receiving attributes mismatched with charging operations or missing information).

Each payload definition text file is parsed into a runtime-specific payload object template, also referred to as a payload specification, which is available for use anywhere in the charging system. Multiple payload specifications can be generated, one for each payload definition text file (and thus one for each type of payload used in the charging system). One or more message builders use the payload specifications to generate payload objects for the various messages exchanged in the charging system. A payload specification represents a particular type of payload, and a payload object generated from the payload specification is an instance of that particular type of payload. Each payload object is populated with attribute values, as defined by the payload specification used to generate the payload object. The payload object is validated to ensure the payload object adheres to the payload specification, and any violations of the payload specification are reported to the subscriber while the payload object is being populated. A validated payload object is used to construct a well-formed message. The message builders will not construct a malformed message, preventing unnecessary runtime charging errors due to malformed payloads (e.g., incomplete and/or invalid payloads). Payload specifications are also versionable, allowing service providers to introduce new attributes in a charging system without requiring extensive programming knowledge or stopping any processes related to the charging engine. The introduction of new attributes while the charging engine is running is critical in some charging domain cases, such as for a pre-paid cell phone service provider whose charging engine must always be on. New versions of a payload specification can be introduced and consumed into a high availability (HA) system without incurring downtime.

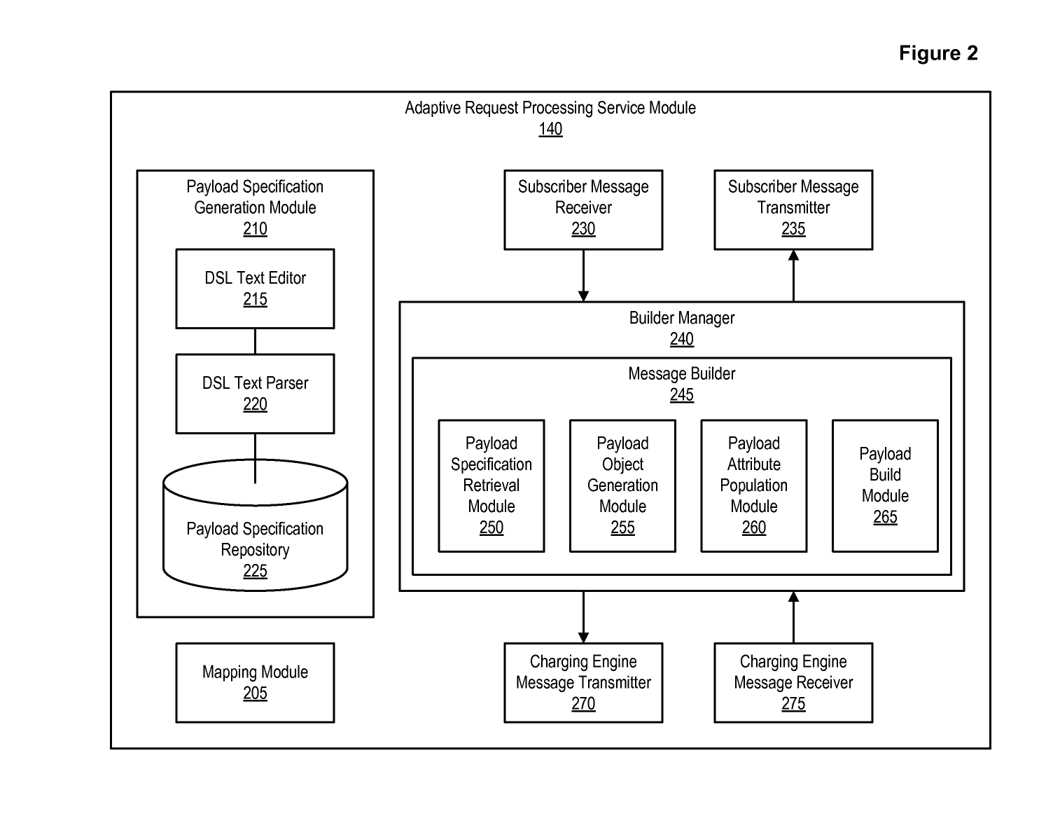

The present disclosure is implemented by adaptive request processing service module 140, which is implemented on mediation system 125. Adaptive request processing service module 140 is discussed in further detail below, in connection with FIG. 2. Since adaptive request processing service module 140 is configured to define and implement a number of different payload attributes that can be specific towards any charging domain, adaptive request processing service module 140 can be implemented in a number of different charging domains. Further, adaptive request processing service module 140 is configured to integrate incompatible ends of a charging system using mapping information defined by the administrator. Adaptive request processing service module 140 is configured to receive information from a gateway in one format (e.g., Diameter protocol attribute value pairs, or AVPs) and is configured to map the information into another format compatible for the service provider's charging engine (e.g., into attributes defined by the service provider, where the charging engine supports the attributes defined by the service provider) and/or external billing/charging engine (if any is implemented in the service provider's charging system). Adaptive request processing service module 140 is also configured to receive information from a charging engine and/or external billing/charging engine in one format and map the information into another format compatible for the gateway. The service provider's charging engine may be built specifically for the service provider's particular charging domain or may be a general-purpose type of charging engine that could be implemented in any charging domain.

Mediation system 125 can be communicatively coupled to gateway 120, elastic charging engine 130, and/or external billing/charging engine 135 via one or more IP (Internet Protocol) networks that utilize Ethernet, IEEE 802.11x, or some other communications protocol. In light of the present disclosure, it will be appreciated that charging system 100 and access network 110 can include other components such as base stations, access gateways, serving gateways, IP networks, servers, routers, switches, firewalls, and the like that are not germane to the discussion of the present disclosure and will not be discussed further herein. It will also be appreciated that other configurations are possible. For example, a large number of distinct user equipment devices and gateways can be implemented in access network 110. Also, charging system 100 may also include additional components not illustrated. Also, a repository and/or a data store discussed herein can be implemented using one or more storage devices (e.g., a single storage device or a collection of storage devices). A storage device can be implemented using network attached storage (NAS), file servers, storage filers, a storage area network (SAN), and the like.

The letter N is used to indicate a variable number of devices or components that are discussed herein. For example, a variable number of payload specifications 515(1)-(N) are stored in payload specification repository 225. Although the letter N is used in describing a variable number of instances of each of these different devices and components herein, a repeated use of the letter N does not necessarily indicate that each device and component has a same number of N instances implemented in the system.

FIG. 2 is a simplified block diagram illustrating components of an example adaptive request processing service module 140 in which the present disclosure can be implemented. Adaptive request processing service module 140 includes a mapping module 205, a payload specification generation module 210, a subscriber message receiver 230, a subscriber message transmitter 235, a thread manager 240, a message builder 245, a charging engine message transmitter 270, and a charging engine message receiver 275. Each component is discussed below.

Payload specification generation module 210 is configured to generate payload specifications from payload definition text files written by an administrator of a service provider. Payload specification generation module 210 includes a DSL (domain specific language) text editor 215, a DSL text parser 220, and a payload specification repository 225. Each component is discussed below.

DSL text editor 215 is configured to provide a user interface (e.g., a graphical user interface (GUI) or a text-based user interface) that is configured to display text entered (e.g., text typed on a keyboard or text selected from a GUI element, such as a drop down menu) by a user or administrator. DSL text editor 215 is configured to implement a DSL, which is a programming language that has a small vocabulary and simplified syntax.

An administrator utilizes DSL text editor 215 to define a payload definition, which is a textual representation of a particular type of payload. A payload definition defines (in text) a number of attributes carried by a particular type of payload used in the charging system. An administrator uses the DSL to define a number of attributes to be included in a payload, where such payload attributes are specific to the charging domain. For example, rather than defining abstract attributes as “Field1” or “Attribute2,” an administrator can accurately describe attributes such as “Call_Duration” in a telephone charging domain, “Distance_Traveled” in a toll road charging domain, “Requested_Video” in a pay per view video charging domain, and the like. Payload attributes that have descriptive names have the benefit of providing an administrator with clearer guidance as to what attributes are necessary for a particular charging operation, thereby preventing runtime charging errors (e.g., errors due to the charging engine receiving mismatched or missing information).

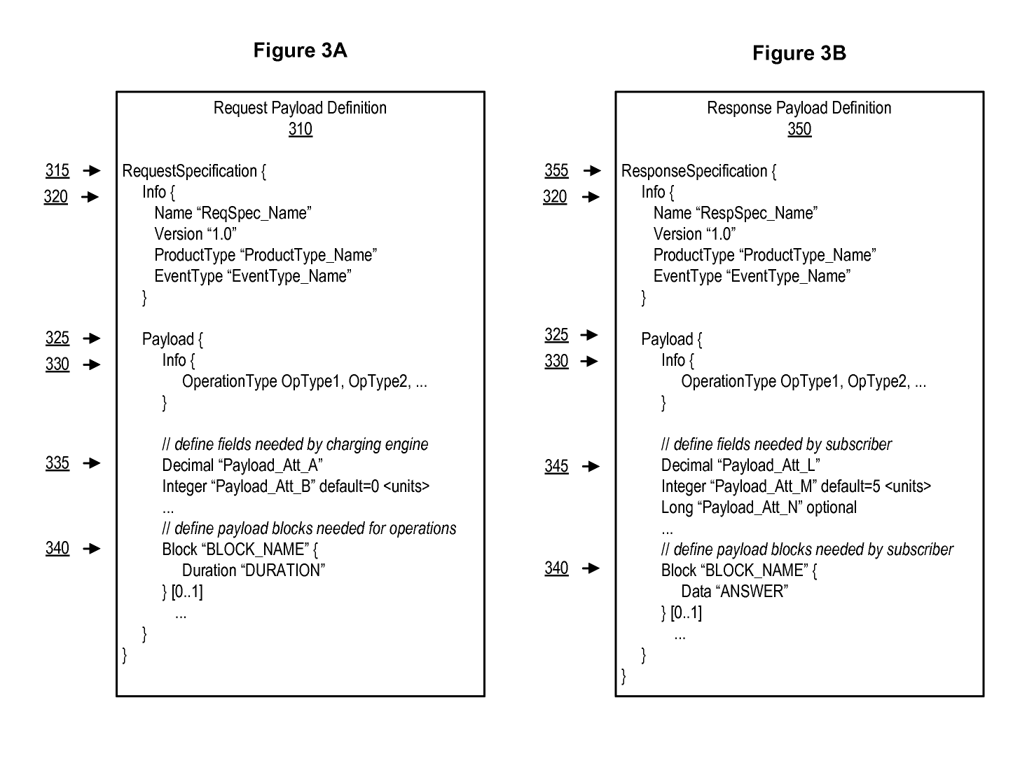

Further, an administrator can use the simplified syntax of the DSL to define the payload attributes and data types included in a payload without being required to have extensive programming knowledge. The DSL's syntax includes well-defined constructs (such as RequestSpecification, ResponseSpecification, Info, Payload, Block, and the like, discussed below) that are used to define the attributes (and data types of those attributes) that are included in a payload. An “optional” keyword also indicates whether a given attribute is optionally included in a payload, rather than required to be included in a payload. The administrator can also define default values or ranges of values for attributes, can define whether zero or more instances of a particular attribute are included in a payload, and can define that the payload is used for a particular type of message (such as charging requests for various types of services). Components of a payload definition text file are further discussed below in connection with FIGS. 3A and 3B.

The payload definition is saved as a text file, which can be stored locally at DSL text editor 215 (e.g., in memory or in a storage device communicatively coupled to DSL text editor 215). In another embodiment, payload definitions can be generated using any text editor, as long as the text adheres to the constructs implemented by the DSL when defining a payload. The administrator can define a number of distinct payload definition text files, one text file for each type of payload expected to be used in the charging domain. The administrator can deploy a payload definition to the charging system by sending the payload definition to DSL text parser 220. New payload definitions can be sent to DSL text parser 220 while the charging engine is running (e.g., without stopping or restarting any components of the charging engine).

DSL text parser 220 is configured to parse the payload definition text files received from DSL text editor 215 into payload specifications. DSL text parser 220 is configured to recognize the constructs used by the administrator to define attributes in a payload definition text file and parse the attributes into a payload specification. A payload specification is a payload object template for a particular type of payload and defines a number of attributes carried by the particular type of payload. One or more payload objects are generated using the payload specification as a template, where the payload objects are instances of that particular type of payload. In one embodiment, DSL text parser 220 is implemented using Scala programming language, or a similar programming language.

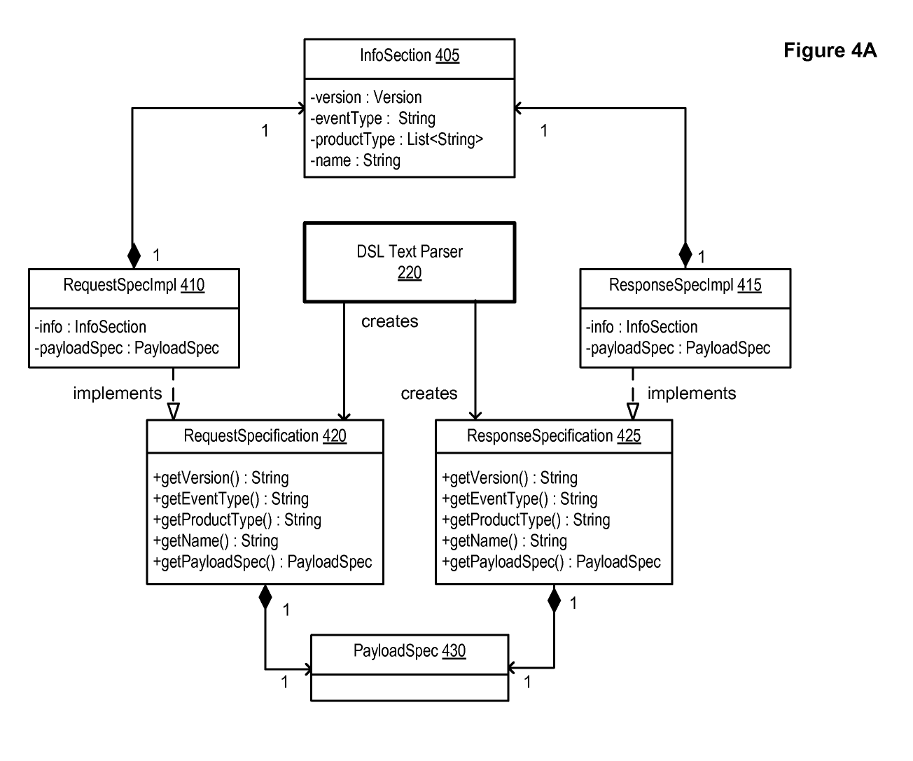

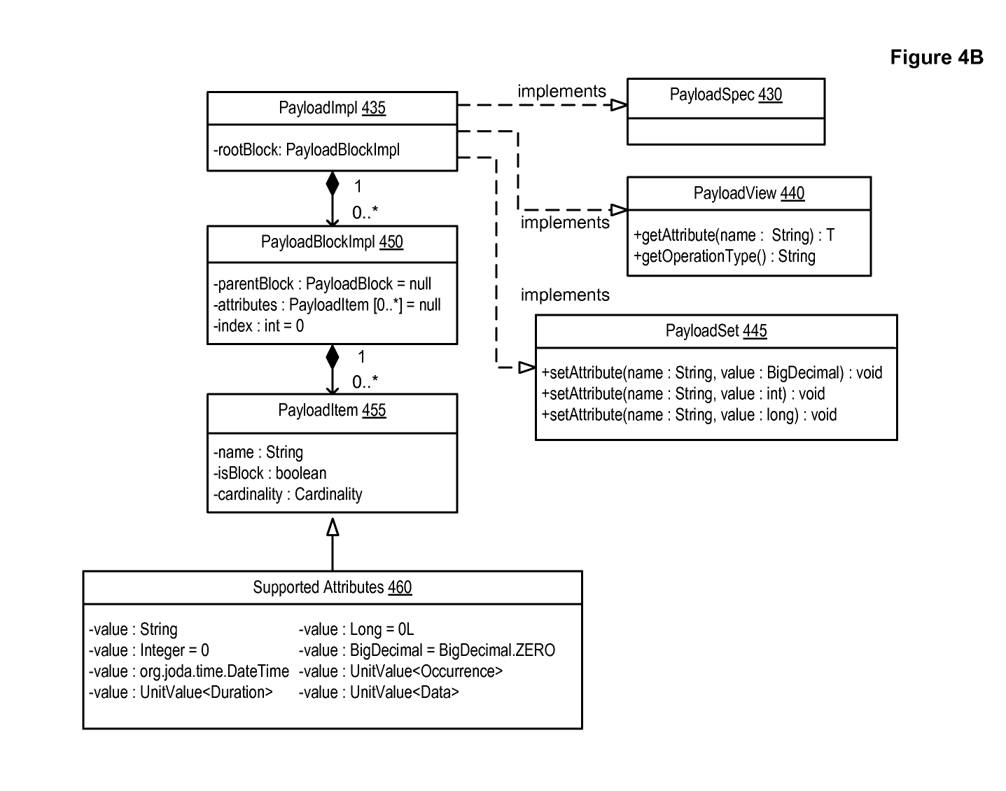

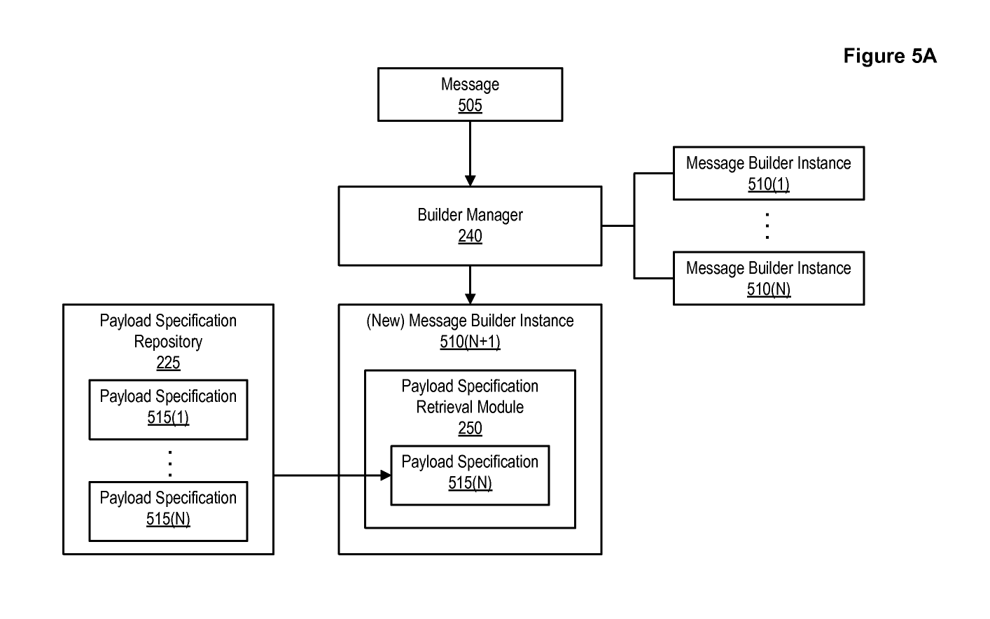

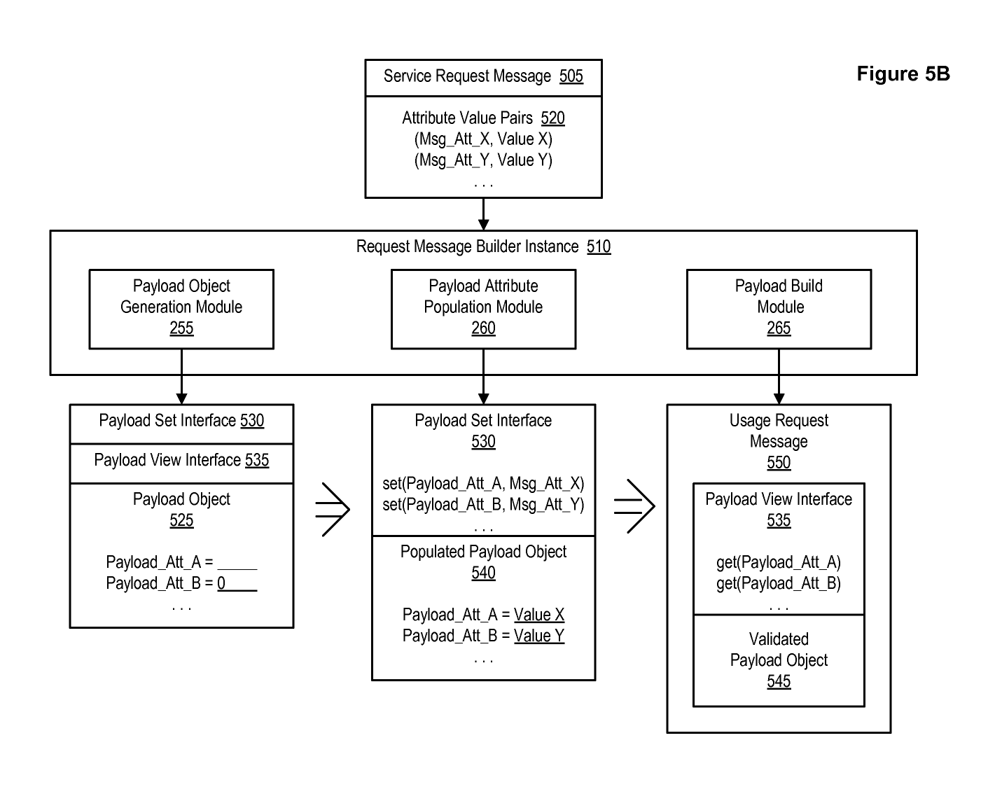

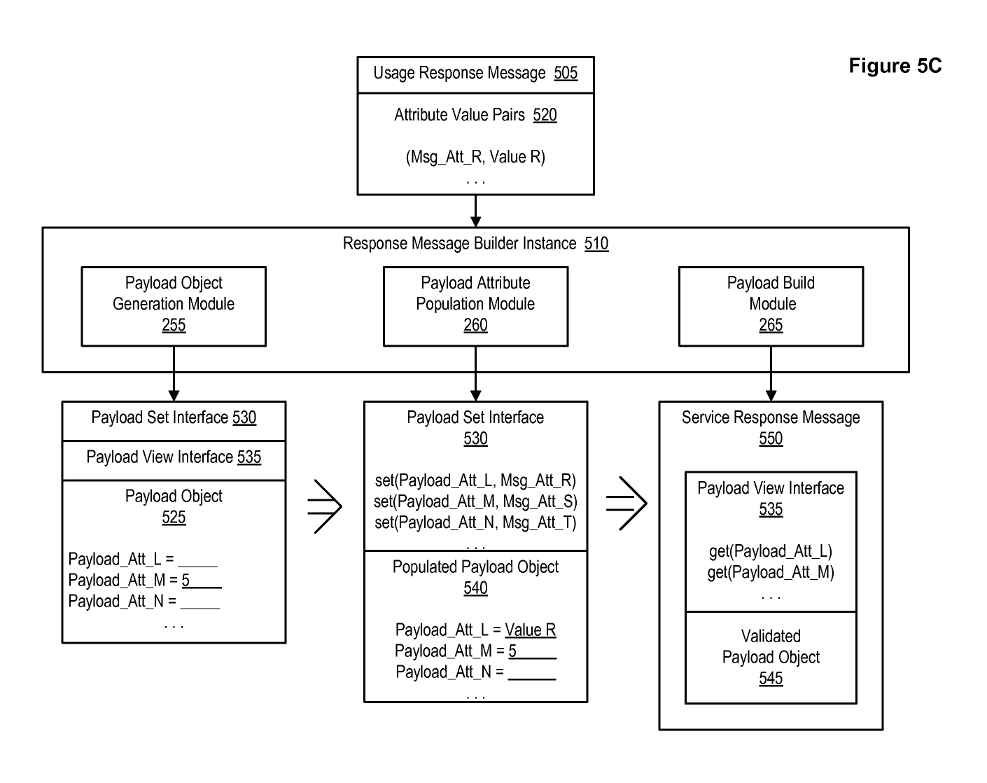

DSL text parser 220 is configured to output two types of payload specifications, a request specification and a response specification, which are used for different types of messages exchanged in the charging system. A request specification is a payload object template that is used to generate a payload object for a request message destined for the charging engine, and a response specification is a payload object template that is used to generate a payload object for a response message destined for the subscriber. An administrator also uses mapping module 205 to define mapping information between information in a format compatible with a gateway (which is coupled to a subscriber's user equipment) and information in a format compatible with the charging engine, where the two formats are not compatible with one another. Mapping module 205 is configured to maintain a mapping table (which is accessible by instances of message builder 245, further described below) that stores mapping information that associates attributes compatible with the gateway with attributes compatible with the charging engine. The request specification and response specification describe how the mapping information is used to translate information of a subscriber's service request into a charging request compatible with the charging engine, and to translate the charging engine's response into a response compatible with the subscriber's gateway, respectively. Payload specifications are further discussed below in connection with FIGS. 4A and 4B, and mapping information is further discussed below in connection with FIGS. 5B and 5C.

DSL text parser 220 stores payload specifications in payload specification repository 225, which is a database or other organized collection of data located on a storage device. Payload specifications are added to repository 225 while the charging engine is running (e.g., without stopping or restarting components of the charging engine). Once stored in repository 225, payload specifications are available for use throughout the charging system. In order to implement a “modified” payload specification, a new instance of the payload specification is created (e.g., an administrator can use a copy of the payload specification's payload definition text file as the source material for the new instance of the payload specification). The new instance can be deployed in the charging system as a new version of the payload specification (where both the original version and new version of the payload specification are available for use in the charging system), or the new instance can overwrite the original instance of the payload specification (such as by the new instance having the same version information as the original instance, replacing the original instance). As further described below, each payload specification is associated with an instance of message builder 245, where the message builder instance generates a payload object that adheres to the associated payload specification.

Subscriber message receiver 230 and subscriber message transmitter 235 are coupled to one or more ports of mediation system 125 (e.g., one or more ports of a server on which mediation system 125 is implemented) that are also communicatively coupled to gateway 120. Subscriber message receiver 230 is configured to receive an incoming message from a subscriber's user equipment 115 via gateway 120. In one embodiment, the incoming message is a service request message that requests usage of a service. Subscriber message transmitter 235 is configured to transmit an outgoing message to the subscriber's user equipment 115 via gateway 120. In one embodiment, the outgoing message is a service response message that is responsive to the subscriber's service request message.

Charging engine message transmitter 270 and charging engine message receiver 275 are coupled to one or more ports of mediation system 125 (e.g., ports of a server on which mediation system 125 is implemented) that are also communicatively coupled to components of elastic charging engine 135 (and also to components of external billing/charging engine 140, if implemented in the charging system). Charging engine message transmitter 270 is configured to transmit an outgoing message to a component of elastic charging engine 130 and/or external billing/charging engine 135. In one embodiment, the outgoing message is a charging request message corresponding to a subscriber's (incoming) service request message. Charging engine message receiver 275 is configured to receive an incoming message from a component of elastic charging engine 130 and/or external billing/charging engine 135. In one embodiment, the incoming message is a charging response message responsive to the charging request message (and corresponds to the (outgoing) service response message).

Builder manager 240 is configured to instantiate and to manage one or more message builders 245. Builder manager 240 is configured to instantiate two types of message builders: a request message builder configured to process an incoming message received from a subscriber, and a response message builder configured to process an incoming message from the charging engine. A request message builder is associated with a request specification, and a response message builder is associated with a response specification. Each instance of message builder 245 includes a payload specification retrieval module 250, a payload object generation module 255, a payload attribute population module 2260, and a payload build module 265. Payload specification retrieval module 250 is configured to retrieve an associated payload specification from payload specification repository 225, as further discussed below in connection with FIG. 5A.

Builder manager 240 is also configured to route an incoming message to the appropriate message builder instance for payload processing. Each message builder instance also has an associated queue or buffer for holding incoming messages in the order that the incoming messages were received at the adaptive request processing service module and routed to the message builder by builder manager 240. Payload object generation module 255 is configured to generate a payload object according to the payload specification associated with the message builder instance. Payload attribute population module is configured to populate the payload object with attributes extracted from the incoming message (in a manner that adheres to the payload specification). Payload build module 265 is configured to build an outgoing message that includes the payload object, where the payload object is validated as the message is built to prevent the creation of any malformed payload objects. Payload build module 265 constructs an outgoing usage request message destined for a charging engine component in response to receiving an incoming service request message from a subscriber, and an outgoing service response message destined for a subscriber in response to receiving an incoming usage response message from a charging engine component. If the outgoing message is successfully built (and the payload object is validated to be a well-formed payload object), payload build module 265 provides the outgoing message to the appropriate transmitter (either subscriber message transmitter 235 or charging engine message transmitter 270), depending on the destination of the outgoing message. The payload processing performed by message builder 245 is further discussed below in connection with FIGS. 5B and 5C.

Builder manager 240 may implement multiple thread processes that implement the one or more message builders. The number of thread processes is dependent on the processing capabilities of the one or more computing devices used to implement adaptive request processing service module 140, as well as dependent on the number of messages received from subscribers and from the charging engine that need to be processed. For example, additional thread processes may be instantiated in order to maintain a predefined level of throughput (e.g., a minimum number of messages that are processed by adaptive request processing service module 140 in a given time period).

FIGS. 3A and 3B illustrate example payload definition text files that are used to generate different types of payload specifications. FIG. 3A illustrates an example request payload definition text file 310 that is used to generate a request payload specification, or more simply a request specification. Request payload definition text file 310 includes a RequestSpecification 315, which is a DSL construct that includes information used to define the request specification. The request specification is a payload object template that is used to generate a payload object for a request message whose destination is the charging engine. FIG. 3B illustrates an example response payload definition text file 350 that is used to generate a response payload specification, or more simply a response specification. Response payload definition text file 350 includes a ResponseSpecification 355, which is a DSL construct that includes information used to define a response specification. The response specification is a payload object template that is used to generate a payload object for a response message whose destination is a subscriber.

RequestSpecification construct 315 and ResponseSpecification construct 355 both include DSL constructs Info 320 and Payload 325. Info construct 320 includes metadata describing the payload specification being defined. As illustrated in FIG. 3A, Info construct 320 describes metadata about the request specification defined in RequestSpecification 315, while Info construct 320 describes metadata about the response specification defined in ResponseSpecification 355 in FIG. 3B. Info construct 320 includes a number of fields, such as a name of the payload specification (“Name”), a version number of the payload specification (“Version”), a name of a product type associated with the payload specification (“ProductType”), and a name of an event type associated with the payload specification (“EventType”).

The payload specification name (“ReqSpec_Name” for the request specification in FIG. 3A and “RespSpec_Name” for the response specification in FIG. 3B) is an identifier of the payload specification. The version number of the payload specification (“1.0” in both FIGS. 3A and 3B) indicates the version of the payload specification, where different version numbers indicate different versions of a payload specification. Multiple versions of a payload specification (e.g., two or more payload specifications that have a same name and different version numbers) may be implemented in the charging system. Subsequent versions of a payload specification can be indicated by incrementing the version number. A message builder instance can be associated with a particular version (e.g., a particular message builder instance is responsible for generation of payload objects from a payload specification with a particular version number).

The product type name (“ProductType_Name” in both FIGS. 3A and 3B) is an identifier that indicates the particular service product to which the payload specification is applicable. A service provider often provides a variety of different service products that a subscriber can use, each of which is identified by a product type name that is unique across all charging components in the charging system.

The event type name (“EventType_Name” in both FIGS. 3A and 3B) is an identifier that indicates a particular triggering event to which the payload specification is applicable. A service product often has a number of events offered to a subscriber, the usage of which is charged to the subscriber. Each event may use a different type of payload to communicate subscriber usage information to the charging engine, or a number of events may use a same type of payload. The payload specification can be associated with one or more event types, where the event type name field can include a single event type name or a list of the multiple event type names. The event type name should also be unique across all charging components in the charging system.

In one embodiment, the event type name also associates the payload specification with the event type's charging plan. Each triggering event may be associated with a different charging or rating plan (referred to herein as simply a charging plan) that is used to calculate charges that arise from a subscriber's service usage of the service product. For example, a Voice product may include different charging plans for a “Voice_Usage” event and a “VOIP_Usage” event (Voice Over IP). A payload specification that includes the combination of the Voice product type and Voice_Usage event type indicates that the payload specification is also associated with the charging plan associated with Voice_Usage.

Payload construct 325 includes information that defines a particular type of payload. As illustrated, Payload construct 325 includes an Info construct 330 and includes zero or more attributes 335 and zero or more Block constructs 340. Info construct 330 includes (but is not limited to) one or more fields, such as a name of a charging operation type (“OperationType” in both FIGS. 3A and 3B). The charging operation type name (“OpType1” in both FIGS. 3A and 3B) is an identifier that indicates a type of charging operation to which the payload is applicable. The payload specification can be associated with one or more operation types, where the operation type name field can include a single operation type name or a list of the multiple operation type names. Charging operations are session-based (e.g., multiple requests over the span of the session using Initiate, Update, and Terminate operations) or event-based (e.g., request for a single event using Terminate operation, also used in offline charging). A unique payload can be defined for each type of charging operation. Example supported operations types include (but are not limited to):

TABLE 1
Charging Operation Types

| Operation Type | Description |
|---|---|
| Initiate | Commencement of a session-based charging operation |
| Update | Continuation of a session-based charging operation |
| Terminate | Conclusion of a single non-session based charging operation |
| Cancel | Complete cancellation of a session-based charging operation |
| Refund_Amount | Refund a specific amount to a specific balance resource |
| Refund_Unit | Refund a calculated amount, based on units consumed, to the |
| | impacted resource(s) |
| Debit_Amount | Debit a specific amount to a specific balance resource |
| Debit_Unit | Debit a calculated amount, based on units consumed, to the |
| | impacted resource(s) |
| Price_Enquiry | Generate a price estimation without any balance reservations |
| | occurring; Used when there is no high probability of receiving a |
| | charging request (e.g., used when there is a low probability of |
| | receiving a charging request). |
| Start_Accounting | Begin tracking usage without incurring balance impacts |
| Update_Accounting | Continue tracking usage without incurring balance impacts |
| Balance_Query | Return the user balance, used for query reqeusts |
| Accounting_On_Off | Clean open session and reservation for a specific network element, |
| | used for management requests |

Attributes 335 are payload attributes that are carried by the particular type of payload for a request message and are relevant to the one or more charging operation types identified in Info construct 330. Attributes 335 represent information relevant to the charging operation types identified in Info construct 330, such as network information and subscriber plan information. As discussed above, payload attributes are defined by an administrator and have descriptive names that better identify the information being conveyed in the particular type of payload. However, for simplicity's sake, generalized attribute names Payload_Att_A and Payload_Att_B are used as examples attribute names in FIG. 3A.

Attributes 345 are payload attributes that are carried by the particular type of payload for a response message and are returned from the one or more charging operation types identified in Info construct 330. Attributes 345 represent information responsive to the request message sent by the subscriber via the gateway. While attributes 335 are compatible with the charging engine, attributes 345 are compatible with the gateway. For simplicity's sake, generalized attribute names Payload_Att_L, Payload_Att_M, and Payload_Att_N are used as example attribute names in FIG. 3B.

The DSL supports a number of data types used to define payload attributes 345 and 335, including (but not limited to): string, integer, datetime (date time stamp), long integer, big decimal, duration (service product usage in milliseconds, seconds, minutes, hours, days, and so on), occurrence (service product usage that involved a particular event occurence), and data (service product usage in bytes, kilobytes, megabytes, gigabytes, and so on). Attributes can be optional (as indicated by an “optional” keyword, as illustrated in FIG. 3B for Payload_Att_N) or include default values (as indicated by a “default” keyword, as illustrated in FIG. 3A for Payload_Att_B).

Block construct 340 also includes one or more payload attributes, which represent subscriber usage information relevant to the charging operation types identified in Info section 330. Payload construct 325 can include a number of Block constructs 340, as indicated by block cardinality located at the end of Block construct 340. Supported block cardinality includes, but is not limited to:
[1] —the payload must contain a single instance of this block.
[0 . . . 1] —the payload can optionally contain a single instance of this block.
[0 . . . 1]—the payload can optionally contain multiple instances of this block.
[1 . . . *]—the payload must contain at least one instance of this block, but can contain multiple instances.

The payload attributes defined in Payload construct 325 (including those defined in Block construct 340) define aspects of the particular event type identified in Info construct 320. The associated charging operation (identified in Info construct 330) uses the attributes in the Payload construct 325 to rate or calculate charges for the particular event type. In this manner, the payload can be constrained to include a limited number of payload attributes that are needed to perform the associated charging operation, rather than including an excessive number of attributes included in a “kitchen sink” type of payload.

Various combinations of product type and event type also indicate when an appropriate payload specification should be used to generate a payload object for a given message. The charging operation associated with the product type and event type combination also uses a charging plan or offer associated with the product type and/or event type to calculate the charges for the subscriber's usage.

Request specifications and response specifications can also be generated for an external billing/charging engine. In such a case, an “external” keyword or flag is used to indicate that the products and events identified in the request or response specification are mapped to service products and events of the external billing/charging engine (e.g., see request specification example 4 below).

Some example payload definition text files for a request specification are provided below:

//Example 1
RequestSpecification {

Info {

Name “Voice_Usage”
Version “1.0”
ProductType “VOICE”
EventType “USAGE”

}
Payload {

Info {

OperationType Initiate, Update, Terminate

```
}
  // identifier for the called party
String “CALLED_ID”
  // id of the cell switch
  String “CELL_ID” default=“”
  // voice QOS
  Decimal “QUALITY_OF_SERVICE” default= 0.0
  // usage direction for mobile to mobile
  Integer “USAGE_DIRECTION” optional
  // provides the reason for the termination request
  String “TERMINATION_CAUSE” default= “”
  ...
  // REQUESTED_UNITS is an identifier block populated
// for “Initiate” and “Update” operations
  Block “REQUESTED_UNITS” {
```

Duration “DURATION”

```
  } [0..1]
// USED_UNITS block populated for “Update” and “Terminate”
// operations
  Block “USED_UNITS” {
```

Duration “DURATION”

```
  } [0..1]
  ...
```

}

}
//Example 2
RequestSpecification {

Info {

Name “Electric_Power”
Version “1.0”
ProductType “Electricity”
EventType “Usage”

}
Payload {

Info {

OperationType Event

}
Long “METER_ID”
Power “QUANTITY” default=0 <watts>
...

}

}
//Example 3
RequestSpecification {

Info {

Name “Mixed_Usage”
Version “1.0”
ProductType “MIXED_SERVICE”
EventType “USAGE”

}
Payload {

Info {

OperationType Initiate, Update, Terminate

}
String “ORIGIN_NETWORK” default=“”
//ID of the cell switch
Integer “CELL_ID” optional
DateTime “TIMESTAMP”
Block “REQUESTED_UNITS” {

Data “VOLUME” default= 0.0 <bytes>
Duration “DURATION” default= 10 <seconds>
Data “OCCURANCE” default= 0 <occ>

} [0..1]
...

}

}
//Example 4
Request Specification {

Info {

Name “Voice_Usage”
Version “1.0”
ProductType “VOICE” -external “/service/telco/voice”

“VOICE2” -external “/service/telco/voice2”
“VOICE3” -external “/service/telco/voice3”

EventType “USAGE” -external “/event/session/telco/usage”

}
Payload {

Info {

OperationType Initiate, Update, Terminate, Debit_Unit,
Price_Enquiry, Update_Accounting

...

}

FIG. 4A is a simplified block diagram illustrating components of an example object model diagram that illustrates the relationships among various object constructs used to implement payload specifications (or payload object templates). The implementation classes 410 and 415 act as base or generic templates that are used to generate different instances of payload specifications, where each payload specification in turn acts as a (specific) template used to generate multiple instances of a particular type of payload. Implementation classes 410 and 415 provide the structure for each payload specification, which includes an InfoSection object construct (corresponding to the Info DSL construct) and a PayloadSpec object construct (corresponding to the Payload DSL construct).

DSL text parser 220 is configured to recognize DSL constructs in a payload definition text file and to parse the text file into a corresponding payload specification instance. For example, in response to recognizing the “RequestSpecification” keyword in the payload definition text file, DSL text parser 220 is configured to utilize RequestSpecImp1 (request specification implementation class) 410 to generate (or create) a new RequestSpecification template 420. DSL text parser 220 is also configured to utilize ResponseSpecImp1 (response specification implementation class) 415 to generate (or create) a new ResponseSpecification template 425 in response to recognizing the “ResponseSpecification” keyword in the payload definition text file. Both RequestSpecImp1 410 and ResponseSpecImp1 415 have an InfoSection 405, which includes the payload specification name, version, product type, and event type definitions. DSL text parser 220 is configured to populate these definitions with the corresponding values that are extracted from the payload specification text file.

Both RequestSpecification template 420 and ResponseSpecification template 425 have a PayloadSpec template 430 that represents the payload, which is further illustrated in FIG. 4B. DSL text parser is configured to use PayloadImp1 (payload implementation class) 435 to generate PayloadSpec template 430, as well as a PayloadView interface 440 and a PayloadSet interface 445 for the PayloadSpec template 430. PayloadImp1 435 also has a PayloadBlockImp1 (payload block implementation class) 450 that supports the creation of any payload blocks that are defined in the payload definition text file. PayloadBlockImp1 450 has a PayloadItem class 455 that supports the cardinality of any payload blocks that are defined in the payload definition text file. PayloadBlockImp1 450 and PayloadImp1 435 use a number of attributes defined in supported attribute implementation class 460, including (but not limited to) string, integer, long integer, decimal, DateTime, occurrence, duration, and data. Supported attribute implementation class 460 acts as another PayloadBlockImp1, allowing a tree structure to be defined, where instances of PayloadBlock (corresponding to the Block DSL construct) defined in a payload can contain other sub-PayloadBlocks.

DSL text parser is configured to recognize constructs defining a number of payload attributes in the payload definition text file and to generate corresponding attributes in PayloadSpec 430. For example, DSL text parser extracts a payload attribute name and associated data type from the text file and generates a corresponding (object) payload attribute in PayloadSpec 430 that has the payload attribute name and associated data type. RequestSpecification 420 and ResponseSpecification 425 are each used to generate instances of a particular payload object, which includes PayloadSpec 430, PayloadView interface 440, and PayloadSet interface 445, which are further discussed below in connection with FIGS. 5B and 5C.

FIG. 5A is a simplified block diagram illustrating an example message builder instantiation process. Each message builder is associated with a payload specification and is responsible for producing a payload object that adheres to the associated payload specification. A payload specification is associated with version information (i.e., the version of the payload specification), service product information, and triggering event information (further discussed below in connection with FIGS. 3A and 3B), which are also used to identify the payload specification's associated message builder (e.g., builder manager 240 maintains a list or table of instantiated message builders 510(1)-(N) and their associated version, product, and event information). When a message 505 is received from a subscriber or from the charging engine, builder manager 240 is configured to identify product, event, and version information included in the message. Builder manager 240 is also configured to identify an existing message builder that is associated with the identified product, event, and version information (e.g., search the list of instantiated message builders for the identified product, event, and version information). If a message builder does not presently exist for the identified product, event, and version information, builder manager 240 instantiates a new message builder 510(N+1) and associates the new message builder with the identified product, event, and version information (e.g., adds the new message builder and product, event, and version information to the list of instantiated message builders).

The new message builder 510(N+1) includes a payload specification retrieval module 250 that is configured to search the payload specification repository 225 and retrieve a payload specification 515(N) that matches the builder's associated product, event, and version information. The new message builder 510 is dedicated to generating instances of the particular payload object defined by the retrieved (and associated) payload specification, for all incoming messages that require this particular payload object. Retrieval of the payload specification from the repository need only occur once when the message builder is instantiated. This avoids repeated interfacing with the repository to select a different payload specification if general (or non-dedicated) message builders were used. If a new version of a payload specification is deployed in the charging system, builder manager 240 is responsible for managing the associated message builder(s), such as instantiating a new message builder associated with a new version (if the new version runs concurrently or simultaneously with the old version) and/or decommissioning the message builder associated with an old version (if the new version replaces or overwrites the old version), without incurring any downtime for the charging engine.

Builder manager 240 routes the incoming message 505 to the appropriate message builder 510 (such as an existing message builder or a newly-instantiated message builder), depending on the product, event, and version information. An incoming message received from a subscriber is routed to a request message builder (which is associated with a request specification that matches the product, event, and version information) and an incoming message received from a charging engine is routed to a response message builder (which is associated with a response specification that matches the product, event, and version information).

FIG. 5B is a simplified block diagram illustrating an example payload object generation process for a message destined for a charging engine. In the example illustrated, a service request message 505 has been received at subscriber message receiver 230, which is routed by builder manager 240 to an appropriate request message builder 510 based on product, event, and version information of message 505, and is placed in the message builder's queue.

In response to detecting that a message has been received in the queue, payload object generation module 255 is configured to generate a payload object from the associated payload specification (i.e., the payload specification associated with the message builder 510). Payload object generation module 255 uses the associated payload specification as an object template to create a new object instance, or payload object 525. Payload object 525 includes a number of attributes relevant to one or more charging operations, as defined by the payload specification used to generate the payload object. Some of the attributes may be defined to have default attribute values, while other attributes may have empty or null values. For example, if request specification 310 (illustrated in FIG. 3A) is used to generate a payload object, the resulting payload object 525 includes (at least) two attributes that are defined in request specification 310, which for simplicity's sake are illustrated as Payload_Att_A and Payload_Att_B (although more descriptive names may be defined). Payload_Att_A includes an empty value, and Payload_Att_B has been defined to include a default value of 0, as indicated by request specification 310.

In one embodiment, payload object 525 also has a number of fixed attributes that are not defined in request specification 310, but are included in every payload object generated by payload object generation module 250. Examples of fixed attributes are userIdentity (the public user identity of the person or entity using the service product, such as a phone number, email address, and the like), requestID (an identifier that uniquely identifies the service product usage, is the same across different operation types, and is used to locate an active session associated with the subscriber), requestStart (the time at which service product usage started, used for Initiate operations for session-based requests), requestEnd (the time at which service product usage ended, which is the same as requestStart for event-based charging, indicating no duration), and sequenceNumber (the sequential session-centric attribute).

Payload object generation module 255 provides payload object 525 to payload attribute population module 260. Payload attribute population module 260 is configured to populate the payload attributes of the payload object with attribute values extracted from the incoming message, using mapping information defined by the administrator. An incoming message from a subscriber can include hundreds of attribute value pairs, or AVPs, that include information about a subscriber's usage and network-related information. However, a charging engine may only need to receive a subset of the hundreds of AVPs that are relevant to a particular charging operation, where the payload object includes the relevant attributes needed by the charging engine to perform the particular charging operation. The mapping information indicates which particular ones of the incoming message's AVPs 520 should be used to populate each payload attribute in accordance with the payload specification. In one embodiment, the mapping information is stored in a mapping table accessible by message builder 510. The mapping table includes a number of table entries, where each entry includes a name of an attribute compatible with the charging engine and a name of an associated attribute compatible with the gateway. Payload attribute population module 260 is configured to perform a lookup for the name of the relevant payload attribute (which is compatible with the charging engine) in the mapping table to find a corresponding entry that includes a name of an associated attribute (which is compatible with the gateway). Payload attribute population module 260 identifies the associated attribute in the incoming message (e.g., uses the associated attribute name to identify an AVP in the message that has a matching attribute name) and extracts the value of the associated attribute from the message (e.g., extracts the value from the AVP that has the matching attribute name).

For each extracted attribute value, payload attribute population module 260 is configured to determine whether the data type of the extracted attribute value matches the data type specified for the corresponding payload attribute, as defined by the payload specification. If the data types match, the payload attribute value pair is valid and the extracted attribute value is set as the payload attribute value in the payload object. If the data types do not match, the payload attribute value pair is invalid and the extracted attribute value is not set in the payload object (which leaves either an empty value or a default value for the payload attribute value).

Payload object 525 includes a payload set interface 530 that is configured to provide write access to the payload attributes in the payload object and a payload view interface 535 that is configured to provide read access to the payload attributes in the payload object. Payload attribute population module 260 is configured to use payload set interface 530 to set the extracted values of the incoming message attributes as the payload attribute values in payload object 525 (e.g., creates a new AVP in the payload object that includes the name of the payload attribute and the extracted value of the incoming message attribute), as defined by the mapping information. The resulting populated payload object 540 includes Payload_Att_A having Value X and Payload_Att_B having Value Y (with the default 0 value overwritten by Value Y).

Payload attribute population module 260 provides populated payload object 540 to payload build module 265, which invokes a build process. Payload build module 265 is configured to build an outgoing message that includes the payload object, where the payload attributes of the payload object are validated as the outgoing message is being built. Payload build module 265 is configured to validate whether all required payload attributes have been successfully (or validly) set in the payload. If any of the required payload attributes have not been successfully set (e.g., required payload attributes have an empty value, or the data type of an extracted message value does not match the data type of the required payload attribute), payload build module 265 determines that the payload object is invalid (and incomplete). Payload attributes that are optional and have an empty value will not result in an invalid payload object.

Payload build module 265 generates an error message when the payload object is determined to be invalid (e.g., the payload object includes a required payload attribute that is associated with an extracted value having a mismatched data type, and/or the payload object includes at least one required payload attribute that has an empty value). The error message indicates the problem (e.g., the information received from the subscriber is invalid or incomplete) and is provided to subscriber message transmitter 235 to be sent to the subscriber via gateway 120. The outgoing message and payload object are discarded, and the message builder goes on to process a next incoming message in the queue. The subscriber may send another service request (or subsequent incoming message) that remedies the error, which will be processed by the message builder instance in the order the incoming message was received. Error messages can be logged and displayed to the administrator. Since the payload object is discarded once payload build module 265 determines that the payload object is invalid (e.g., a payload attribute is not successfully set or that the payload object does not include all required payload attributes), payload build module will not allow the creation of any outgoing message that is in violation of the payload specification.

If all required payload attributes have been successfully set (e.g., all required payload attributes have a non-empty value that matches the data type indicated in the payload specification), the payload object is valid (and well-formed) and the outgoing message is forwarded to the destination. Since the incoming message is a service request message from a subscriber, the message builder instance is configured to generate an outgoing usage request message 550 destined for the charging engine, which is sent via charging engine message transmitter 270. At this point, payload set interface 530 is no longer available and the validated payload object 545 can no longer be modified by the mediation system (or client-side components of the charging system). The charging engine is configured to use payload view interface 540 to read the values of the relevant attributes in the payload object and perform the associated charging operation(s).

In one embodiment, the charging engine (or server-side components of the charging system) may be able to mutate the payload via a payload mutator. A service provider administrator can implement one or more customization plug-ins, or payload mutators that are configured to modify a payload object, depending on a set of business rules. Payload mutators are configured to mutate (e.g., change, overwrite) values of an existing payload before and after charging behavior has occurred. For example, a subscriber may initiate a cell phone call that falls under a particular charging plan associated with the product used by the subscriber and particular triggering event. The mediation system creates a payload corresponding to the cell phone call, which is sent to the charging engine for charging. However, if the cell phone call has a poor connection or has low quality, the business rules indicate that the charging engine (or component thereof) should change the call duration to zero to avoid charging the subscriber. To do so, the charging engine executes a payload mutator configured to change the existing call duration value of the payload to zero, even after the cell phone call is complete. In light of the present disclosure, it will be further appreciated that the payload can be re-associated with the payload specification to offer the full gamut of modifications that were available at the time the payload was originally created by the mediation client.

FIG. 5C is a simplified block diagram illustrating an example payload object generation process for a message destined for a subscriber. In the example illustrated, a usage response message 505 has been received at charging engine message receiver 275, which is routed by builder manager 240 to an appropriate response message builder 510 based on product, event, and version information of message 505, and is placed in the message builder's queue.

In response to detecting that a message has been received in the queue, payload object generation module 255 is configured to generate a payload object from the associated payload specification. In the example illustrated in FIG. 5C, payload object 525 is generated using response specification 350 and includes Payload_Att_L, Payload_Att_M, and Payload_Att_N, which are attribute names used by the format that is compatible with the gateway (e.g., AVPs of Diameter protocol). Payload_Att_L and Payload_Att_N have empty values and Payload_Att_M has been defined to include a default value of 5, as indicated by the response specification 350.

Payload attribute population module 260 is configured to populate the payload attributes of the payload object with values from AVPs 520 using payload set interface 530, as defined by the mapping information. The AVPs from the incoming message are compatible with the charging engine (e.g., have descriptive names). The mapping information indicates which particular ones of the incoming message attributes 520 should be used to populate each payload attribute in accordance with the payload specification. In one embodiment, payload attribute population module 260 is configured to perform a lookup for the name of the payload attribute (which is compatible with the gateway) in the mapping table to find a corresponding entry that includes a name of an associated attribute (which is compatible with the charging engine). Payload attribute population module 260 identifies the associated attribute in the incoming message, extracts the value of the associated attribute from the message, and sets the payload attribute in the payload object with the extracted value if the data types match. The resulting populated payload object 540 includes Payload_Att_L with Value R, Payload_Att_M with default value 5 (which was not overwritten with any values extracted from AVPs 520), and Payload_Att_N with empty value.

Payload build module 265 validates the attributes of the payload object and builds an outgoing message that includes the payload object. Since Payload_Att_N is an optional attribute, the empty value does not trigger an invalid error. If the required payload attributes have been successfully set, the payload object is valid and the outgoing message is forwarded to the destination. Since the incoming message is a usage response message from a charging engine, the message builder is configured to generate an outgoing service response message 550 destined for the subscriber, which is sent via subscriber message transmitter 235 to the gateway. At this point, payload set interface 530 is no longer available and the validated payload object 545 can no longer be modified by the mediation system (or client-side components of the charging system), but may be modified by the charging system (or server-side components of the charging system) using a payload mutator, as discussed above in connection with FIG. 5B. The gateway is configured to use payload view interface 535 to read the values of the payload attributes in the payload object.

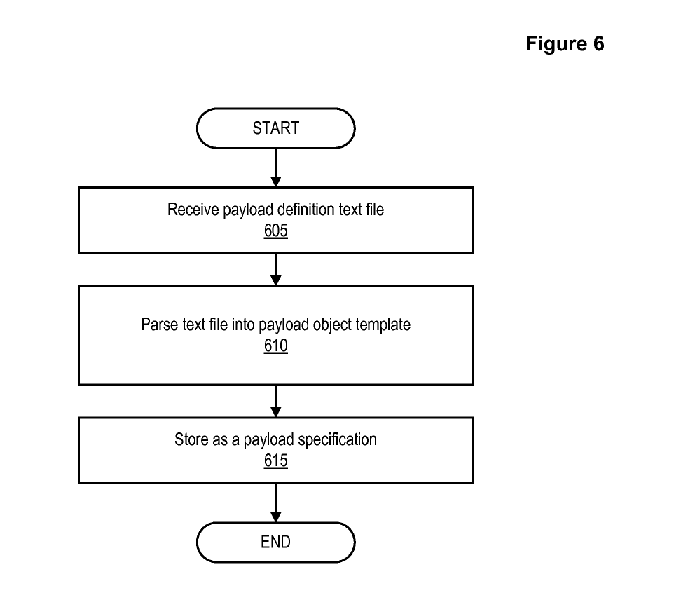

FIG. 6 is a flowchart illustrating an example payload specification generation process performed by payload specification generation module of adaptive request processing service module. The process illustrated in FIG. 6 starts at operation 605, where payload specification generation module receives a payload definition text file that adheres to the constructs defined by DSL. A payload definition text file can be received as a text file that was generated using an external text editor, or can be generated using a DSL text editor of payload specification generation module. The process continues to operation 610, where a DSL text parser of payload specification generation module parses the payload definition text file into a payload object template. The process continues to operation 615, where the DSL text parser stores the payload object template as a payload specification in payload specification repository. The process then ends.

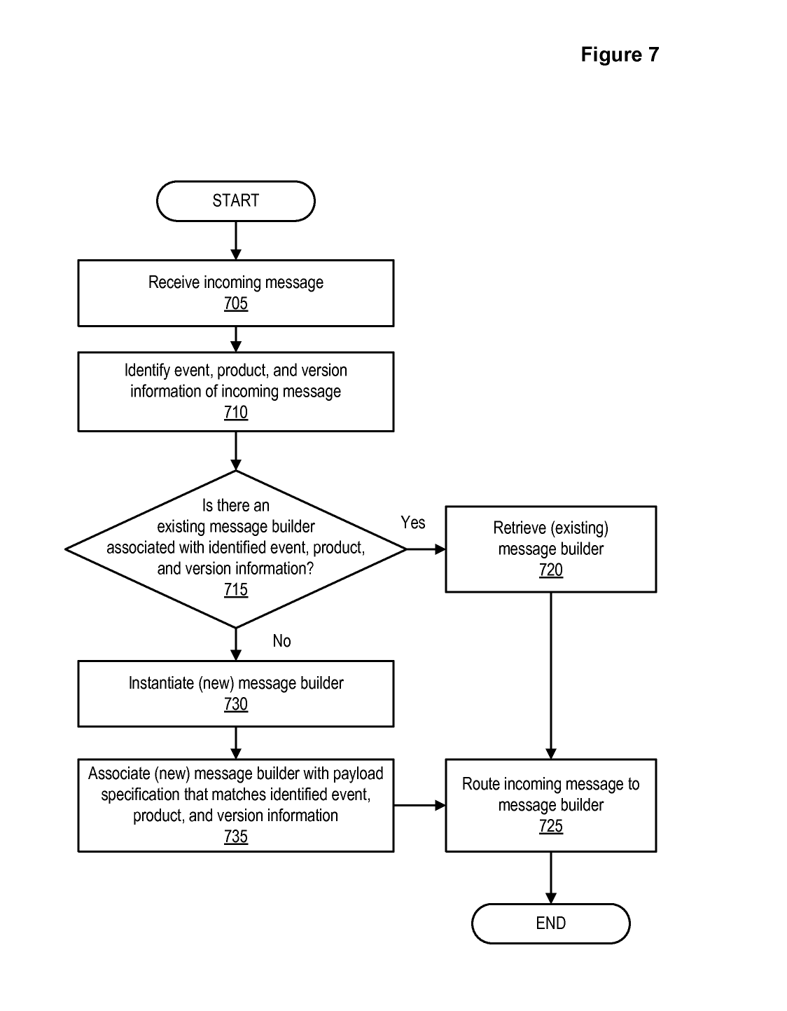

FIG. 7 is a flowchart illustrating an example builder management process performed by a builder manager of adaptive request processing service module. The process illustrated in FIG. 7 starts at operation 705, where an incoming message is received at adaptive request processing service module and routed to the builder manager. The incoming message may be received from a subscriber via a gateway (e.g., is received at subscriber message receiver and routed internally to the builder manager) or from a charging engine (e.g., is received at charging engine message receiver and routed internally to the builder manager). The process continues to operation 710, where the builder manager identifies event, product, and version information of the incoming message.

The process continues to operation 715, where the builder manager determines whether there is an existing message builder associated with the identified event, product, and version information. If there is an existing message builder, the process continues to operation 720, where builder manager retrieves the message builder (e.g., calls or requests the message builder). The process continues to operation 725, where the builder manager routes the incoming message to the (existing) message builder for payload processing. The process then ends.

Returning to operation 715, if there is no existing message builder associated with the identified event, product, and version information, the process continues to operation 730, where the builder manager instantiates a new message builder. The process continues to operation 735, where the builder manager associates the message builder with a payload specification that matches the identified event, product, and version number. The instantiated message builder includes a payload specification retrieval module, which uses the event, product, and version number to search for and retrieve a payload specification from the payload specification repository, where the retrieved payload specification matches the identified event, product, and version number. The process continues to operation 725, where the builder manager routes the incoming message to the (new) message builder for payload processing. The process then ends.

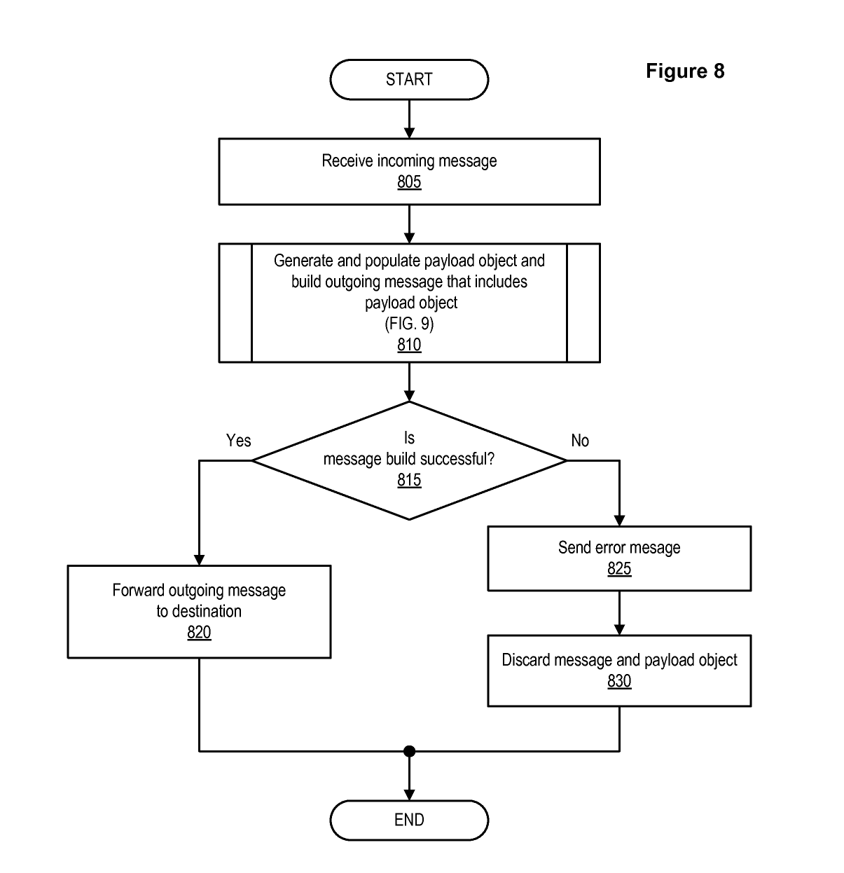

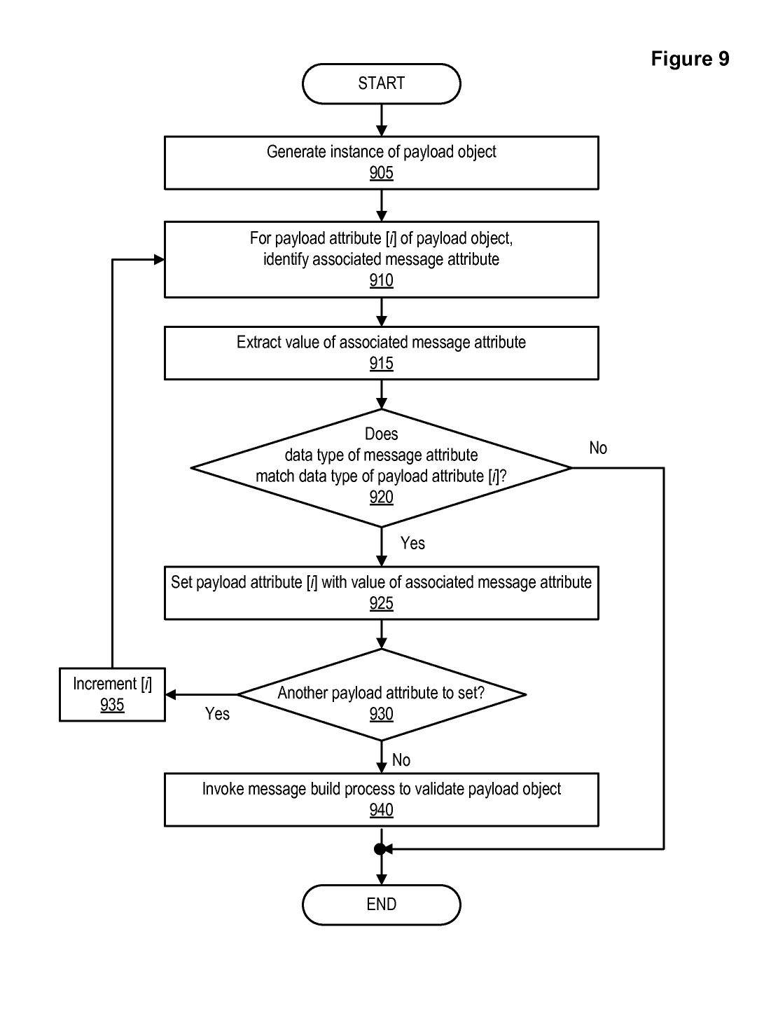

FIG. 8 is a flowchart illustrating an example message generation process performed by a message builder instance. The message builder instance is utilized to generate an outgoing message for an incoming message that matches the message builder's associated product, event, and version information. The process illustrated in FIG. 8 starts at operation 805, where the message builder receives an incoming message in the message builder's queue. The incoming message was routed to the message builder's queue by the builder manager in the order the incoming message was received. The process continues to operation 810, where the message builder generates and populates a payload object using the payload specification associated with the message builder, and builds an outgoing message that includes the payload object. Operation 810 is cooperatively performed by a payload object generation module, a payload attribute population module, and a payload build module. Operation 810 is discussed in further detail in connection with FIG. 9.

The process continues to operation 815, where the message builder determines whether the message build operation is successful. If the build is successful, the process continues to operation 820, where message builder forwards the resulting outgoing message to the destination. The outgoing message may be transmitted to a subscriber via a gateway (e.g., is routed to and transmitted from subscriber message transmitter) or to a charging engine (e.g., is routed to and transmitted from charging engine message receiver). The process then ends.

Returning to operation 815, if the message and payload object build operation is not successful, the process continues to operation 825, where the message builder sends an error message to the subscriber. The process continues to operation 830, where the message builder discards the message and the payload object. The process then ends.

FIG. 9 is a flowchart illustrating an example payload object generation, payload object population, and message build process performed in cooperation by a payload object generation module, a payload attribute population module, and a payload build module of the message builder. The process illustrated in FIG. 9 starts at operation 905, where payload object generation module generates an instance of a payload object, using the payload specification associated with the message builder. Payload object generation module provides the payload object to payload attribute population module.

The process continues to operation 910, where payload attribute population module identifies a message attribute that is associated with payload attribute [i] of the payload object. The payload object includes a number of payload attributes, where the letter [i] acts as a counter that indicates a present payload attribute being processed (where i is initialized to one in operation 905). In one embodiment, payload attribute population module performs a lookup for the name of payload attribute [i] in a mapping table, where the lookup returns an associated attribute name. The process continues to operation 915, where payload attribute population module extracts the value of the associated message attribute from the incoming message. In one embodiment, payload attribute population module finds the associated attribute (which was returned from the mapping table in operation 910) in the incoming message (e.g., finds the AVP in the incoming message with an attribute name that matches the returned associated attribute name) and extracts the value from the incoming message.

The process continues to operation 920, where payload attribute population module determines whether the data type of the message attribute value matches the data type of the payload attribute [i] value. If the data types do not match, payload attribute population module does not set the payload attribute with the value having mismatched data type. At this point, the payload attribute population module is aware the payload object is invalid due to mismatched data type, and can override the remaining portion of the process illustrated in FIG. 9. The process ends, returning to FIG. 8. In such a case, the build process is not successful, indicating that an error message is sent to the subscriber and the message and payload object are discarded.

Returning to operation 920, if the data types of the message attribute value and payload attribute [i] value match, the process continues to operation 925, where payload attribute population module sets the payload attribute [i] with the extracted value of the associated message attribute. The process continues to operation 930, where payload attribute population module determines whether there is another payload attribute to set in the payload object. If so, the process continues to operation 935, where [i] is incremented to indicate a next payload attribute is being processed, and the process returns to operation 910.

Returning to operation 930, if there are no other payload attributes to set in the payload object, the process continues to operation 940, where payload attribute population module invokes a message build process. The message build process is performed by payload build module, which builds an outgoing message and validates the payload object that is included in the outgoing message. Payload build module determines whether all required payload attributes are included in the payload object. A payload attribute that is not designated as an optional attribute is a required payload attribute. All required payload attributes need to be set with an appropriate value for the charging engine in order to avoid a run time charging error (e.g., in order to avoid empty values, an administrator can define default values for the required payload attributes in the payload definition text file). If at least one required payload attribute has an empty value, the payload object is determined to be invalid, and the payload build module generates an error message for the subscriber, indicating that the present error relates to missing required payload attributes. Optional attributes that have empty values do not trigger an error message. If all required payload attributes are included in the payload object, the payload object is determined to be valid. In both cases, the process then ends (and returns to FIG. 8).

### An Example Computing and Network Environment

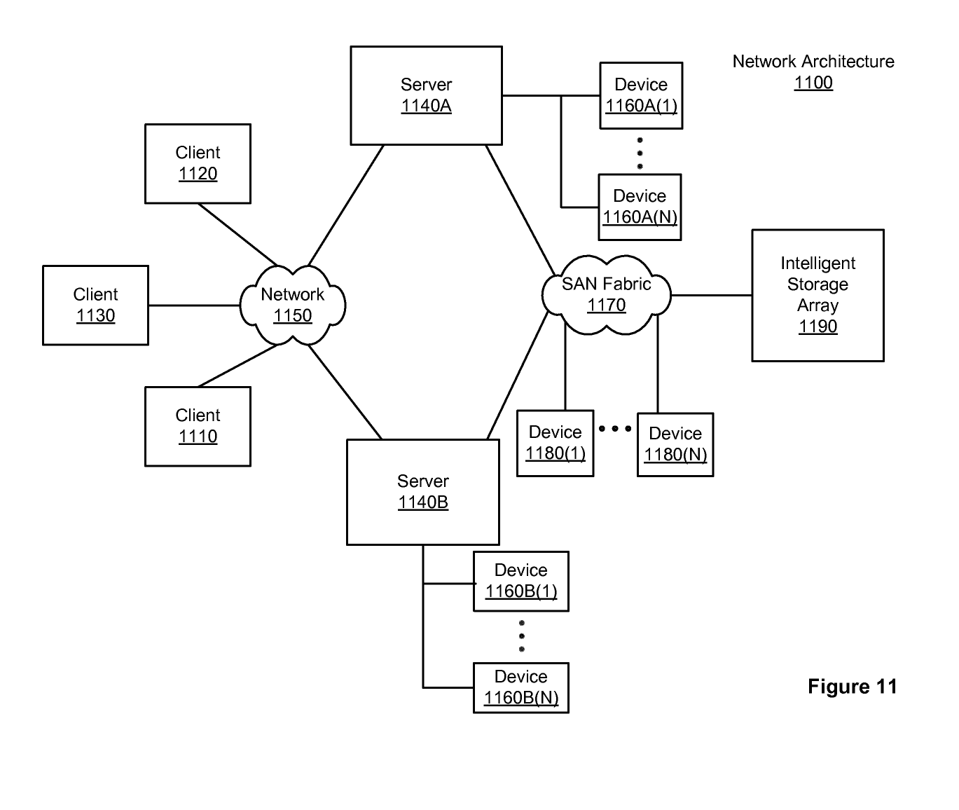

As shown above, the present invention can be implemented using a variety of computer systems and networks. An example of one such computing and network environment is described below with reference to FIGS. 10 and 11.

FIG. 10 depicts a block diagram of a computer system 1010 suitable for implementing aspects of the present invention (e.g., for implementing computing devices for implementing various system components, such as user equipment 115, gateway 120, mediation system 125, elastic charging engine 130 and/or external billing/charging engine 135). Computer system 1010 includes a bus 1012 which interconnects major subsystems of computer system 1010, such as a central processor 1014, a system memory 1017 (typically RAM, but which may also include ROM, flash RAM, or the like), an input/output controller 1018, an external audio device, such as a speaker system 1020 via an audio output interface 1022, an external device, such as a display screen 1024 via display adapter 1026, serial ports 1028 and 1030, a keyboard 1032 (interfaced with a keyboard controller 1033), a storage interface 1034, a floppy disk drive 1037 operative to receive a floppy disk 1038, a host bus adapter (HBA) interface card 1035A operative to connect with a Fibre Channel network 1090, a host bus adapter (HBA) interface card 1035B operative to connect to a SCSI bus 1039, and an optical disk drive 1040 operative to receive an optical disk 1042. Also included are a mouse 1046 (or other point-and-click device, coupled to bus 1012 via serial port 1028), a modem 1047 (coupled to bus 1012 via serial port 1030), and a network interface 1048 (coupled directly to bus 1012).

Bus 1012 allows data communication between central processor 1014 and system memory 1017, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 1010 are generally stored on and accessed via a computer-readable medium, such as a hard disk drive (e.g., fixed disk 1044), an optical drive (e.g., optical drive 1040), a floppy disk unit 1037, or other storage medium. Additionally, applications can be in the form of electronic signals modulated in accordance with the application and data communication technology when accessed via network modem 1047 or interface 1048.

Storage interface 1034, as with the other storage interfaces of computer system 1010, can connect to a standard computer-readable medium for storage and/or retrieval of information, such as a fixed disk drive 1044. Fixed disk drive 1044 may be a part of computer system 1010 or may be separate and accessed through other interface systems. Modem 1047 may provide a direct connection to a remote server via a telephone link or to the Internet via an internet service provider (ISP). Network interface 1048 may provide a direct connection to a remote server via a direct network link to the Internet via a POP (point of presence). Network interface 1048 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 10 need not be present to practice the present invention. The devices and subsystems can be interconnected in different ways from that shown in FIG. 10. The operation of a computer system such as that shown in FIG. 9 is readily known in the art and is not discussed in detail in this application. Code to implement the present invention can be stored in computer-readable storage media such as one or more of system memory 1017, fixed disk 1044, optical disk 1042, or floppy disk 1038. The operating system provided on computer system 1010 may be MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present invention may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

FIG. 11 is a block diagram depicting a network architecture 1100 in which client systems 1110, 1120 and 1130, as well as storage servers 1140A and 1140B (any of which can be implemented using computer system 1010), are coupled to a network 1150. Storage server 1140A is further depicted as having storage devices 1160A(1)-(N) directly attached, and storage server 1140B is depicted with storage devices 1160B(1)-(N) directly attached. Storage servers 1140A and 1140B are also connected to a SAN fabric 1170, although connection to a storage area network is not required for operation of the invention. SAN fabric 1170 supports access to storage devices 1180(1)-(N) by storage servers 1140A and 1140B, and so by client systems 1110, 1120 and 1130 via network 1150. Intelligent storage array 1190 is also shown as an example of a specific storage device accessible via SAN fabric 1170.

With reference to computer system 1110, modem 1047, network interface 1048 or some other method can be used to provide connectivity from each of client computer systems 1110, 1120 and 1130 to network 1150. Client systems 1110, 1120 and 1130 are able to access information on storage server 1140A or 1140B using, for example, a web browser or other client software (not shown). Such a client allows client systems 1110, 1120 and 1130 to access data hosted by storage server 1140A or 1140B or one of storage devices 1160A(1)-(N), 1160B(1)-(N), 1180(1)-(N) or intelligent storage array 1190. FIG. 11 depicts the use of a network such as the Internet for exchanging data, but the present invention is not limited to the Internet or any particular network-based environment.

### Other Embodiments

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

The foregoing describes embodiments including components contained within other components (e.g., the various elements shown as components of computer system 1010). Such architectures are merely examples, and, in fact, many other architectures can be implemented which achieve the same functionality. In an abstract but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

The foregoing detailed description has set forth various embodiments of the present invention via the use of block diagrams, flowcharts, and examples. It will be understood by those within the art that each block diagram component, flowchart step, operation and/or component illustrated by the use of examples can be implemented, individually and/or collectively, by a wide range of hardware, software, firmware, or any combination thereof, including the specialized system illustrated in FIG. 1.

The present invention has been described in the context of fully functional computer systems; however, those skilled in the art will appreciate that the present invention is capable of being distributed as a program product in a variety of forms, and that the present invention applies equally regardless of the particular type of computer-readable media used to actually carry out the distribution. Examples of computer-readable media include computer-readable storage media, as well as media storage and distribution systems developed in the future.

The above-discussed embodiments can be implemented by software modules that perform one or more tasks associated with the embodiments. The software modules discussed herein may include script, batch, or other executable files. The software modules may be stored on a machine-readable or computer-readable storage media such as magnetic floppy disks, hard disks, semiconductor memory (e.g., RAM, ROM, and flash-type media), optical discs (e.g., CD-ROMs, CD-Rs, and DVDs), or other types of memory modules. A storage device used for storing firmware or hardware modules in accordance with an embodiment of the invention can also include a semiconductor-based memory, which may be permanently, removably or remotely coupled to a microprocessor/memory system. Thus, the modules can be stored within a computer system memory to configure the computer system to perform the functions of the module. Other new and various types of computer-readable storage media may be used to store the modules discussed herein.

The above description is intended to be illustrative of the invention and should not be taken to be limiting. Other embodiments within the scope of the present invention are possible. Those skilled in the art will readily implement the steps necessary to provide the structures and the methods disclosed herein, and will understand that the process parameters and sequence of steps are given by way of example only and can be varied to achieve the desired structure as well as modifications that are within the scope of the invention. Variations and modifications of the embodiments disclosed herein can be made based on the description set forth herein, without departing from the scope of the invention.

Consequently, the invention is intended to be limited only by the scope of the appended claims, giving full cognizance to equivalents in all respects.

What is claimed is:

1. A method comprising:
generating a payload object, wherein
the payload object is generated using a message builder associated with a payload specification,
the payload specification defines a plurality of payload attributes, and
the payload object comprises the plurality of payload attributes;
populating the plurality of payload attributes with message attribute values, wherein
the message attribute values are extracted from an incoming message; and
validating the plurality of payload attributes of the payload object.

2. The method of claim 1, further comprising:
building an outgoing message that comprises the payload object; and
forwarding the outgoing message to a destination, wherein
the destination comprises one of a subscriber and a charging engine.

3. The method of claim 1, further comprising:
identifying a message type of the incoming message;
determining service product and event information from the incoming message; and
instantiating the message builder, based on the message type and service product and event information, wherein
the payload specification is retrieved from a repository of payload specifications.

4. The method of claim 3, further comprising:
searching the repository for the payload specification, wherein
the payload specification is associated with the message type, and
the payload specification comprises information that matches the service product and event information.

5. The method of claim 1, wherein the populating comprises
identifying a message attribute associated with a first payload attribute of the plurality of payload attributes;
extracting a value of the message attribute from the incoming message; and
setting the first payload attribute with the value.

6. The method of claim 5, further comprising:
determining whether a first data type of the value matches a second data type of the first payload attribute, wherein
the first payload attribute is set with the value in response to a determination that the first data type matches the second data type.

7. The method of claim 1, further comprising:
discarding the payload object in response to a determination that at least one payload attribute of the plurality of payload attributes is invalid, wherein
the at least one payload attribute is invalid in response to determining at least one of:
a data type of an extracted message attribute value associated with the at least one payload attribute violates the payload specification, and
the at least one payload attribute is a required payload attribute that is populated with an empty value.

8. A non-transitory computer readable storage medium configured to store program instructions that, when executed on a processor, are configured to cause the processor to perform a method comprising:
generating a payload object, wherein
the payload object is generated using a message builder associated with a payload specification,
the payload specification defines a plurality of payload attributes, and
the payload object comprises the plurality of payload attributes;
populating the plurality of payload attributes with message attribute values, wherein
the message attribute values are extracted from an incoming message; and
validating the plurality of payload attributes of the payload object.

9. The non-transitory computer readable storage medium of claim 8, wherein the method further comprises:
building an outgoing message that comprises the payload object; and
forwarding the outgoing message to a destination, wherein
the destination comprises one of a subscriber and a charging engine.

10. The non-transitory computer readable storage medium of claim 8, wherein the method further comprises:
identifying a message type of the incoming message;
determining service product and event information from the incoming message; and
instantiating the message builder, based on the message type and service product and event information, wherein
the payload specification is retrieved from a repository of payload specifications.

11. The non-transitory computer readable storage medium of claim 10, wherein the method further comprises:
searching the repository for the payload specification, wherein
the payload specification is associated with the message type, and
the payload specification comprises information that matches the service product and event information.

12. The non-transitory computer readable storage medium of claim 8, wherein the populating comprises
identifying a message attribute associated with a first payload attribute of the plurality of payload attributes;
extracting a value of the message attribute from the incoming message; and
setting the first payload attribute with the value.

13. The non-transitory computer readable storage medium of claim 12, wherein the method further comprises:
determining whether a first data type of the value matches a second data type of the first payload attribute, wherein
the first payload attribute is set with the value in response to a determination that the first data type matches the second data type.

14. The non-transitory computer readable storage medium of claim 9, wherein the method further comprises:
discarding the payload object in response to a determination that at least one payload attribute of the plurality of payload attributes is invalid, wherein
the at least one payload attribute is invalid in response to determining at least one of:
a data type of an extracted message attribute value associated with the at least one payload attribute violates the payload specification, and
the at least one payload attribute that is populated with an empty value violates the payload specification.

15. An apparatus comprising:
a processor; and
a memory coupled to the processor and configured to store instructions executable by the processor, the instructions configured to implement
a payload object generation module configured to generate a payload object, wherein
the payload object is generated using a message builder associated with a payload specification,
the payload specification defines a plurality of payload attributes, and
the payload object comprises the plurality of payload attributes;
a payload attribute population module configured to populate the plurality of payload attributes with message attribute values, wherein
the message attribute values are extracted from an incoming message; and
a payload build module configured to validate the plurality of payload attributes of the payload object.

16. The apparatus of claim 15, wherein the payload build module is further configured to
build an outgoing message that comprises the payload object, and
forward the outgoing message to a destination, wherein
the destination comprises one of a subscriber and a charging engine.

17. The apparatus of claim 15, wherein the payload object generation module is further configured to
identify a message type of the incoming message;
determine service product and event information from the incoming message; and
instantiate the message builder, based on the message type and service product and event information, wherein
the payload specification is retrieved from a repository of payload specifications.

18. The apparatus of claim 17, wherein the payload object generation module is further configured to
search the repository for the payload specification, wherein
the payload specification is associated with the message type, and
the payload specification comprises information that matches the service product and event information.

19. The apparatus of claim 15, wherein the payload attribute population module is further configured to
identify a message attribute associated with a first payload attribute of the plurality of payload attributes;
extract a value of the message attribute from the incoming message; and
set the first payload attribute with the value.

20. The apparatus of claim 19, wherein the payload attribute population module is further configured to
determine whether a first data type of the value matches a second data type of the first payload attribute, wherein
the first payload attribute is set with the value in response to a determination that the first data type matches the second data type.
